(19) United States
(12) Patent Application Publication
(10) Pub. No.: US 2006/0187795 A1
(43) Pub. Date: Aug. 24, 2006

(54) Branch photocycle technique for holographic recording in bacteriorhodopsin

(76) Inventors: Steve Redfield, Falls Church, VA (US); Tim Harvey, Fairfax, VA (US)

Correspondence Address: HOWISON & ARNOTT, L.L.P, P.O. BOX 741715, DALLAS, TX, 75374-1715, US

(21) Appl. No.: 11/251,575

(22) Filed: Oct. 14, 2005

Related U.S. Application Data
(60) Provisional application No. 60/618,921, filed on Oct. 14, 2004.
(60) Provisional application No. 60/618,917, filed on Oct. 14, 2004.
(60) Provisional application No. 60/618,916, filed on Oct. 14, 2004.

(51) Int. Cl. G11B 7/00

(52) U.S. Cl. 369/103

(57) ABSTRACT

A method of storing information in a protein-based medium having long-lived nonvolatile or near-nonvolatile states is disclosed. The method includes preexposing a bacteriorhodopsin medium to a preexposure pump beam for a predetermined length of time, providing a reference beam and a data beam from a coherent light source, the data beam being modulated to transmit data, and concurrently exposing the bacteriorhodopsin medium to the reference beam and the data beam for a length of time sufficient to form a holographic representation of the data in the medium and subsequently read the hologram. Also included is a method exposing the medium to essentially fully utilize the available index change and share the available index change between N multiplexed holograms in a holographic data storage system.

### CROSS REFERENCE TO RELATED APPLICATIONS

This application claims the benefit of: U.S. Provisional Application No. 60/618,921, filed Oct. 14, 2004, titled “USES OF WAVE GUIDED MINIATURE HOLOGRAPHIC SYSTEM,” U.S. Provisional Application No. 60/618,917, filed Oct. 14,2004, titled “MINIATURE GUIDED WAVELENGTH MULTIPLEXED HOLOGRAPHIC STORAGE SYSTEM,” and U.S. Provisional Application No. 60/618,916, filed Oct. 14, 2004, titled “BRANCH PHOTOCYCLE TECHNIQUE FOR HOLOGRAPHIC RECORDING IN BACTERIORHODOPSIN,” which are hereby incorporated by reference. This application is related to, and is being filed concurrently with, U.S. patent application Ser. No.______ , titled “USES OF WAVE GUIDED MINIATURE HOLOGRAPHIC SYSTEM”, to be assigned to Starzent, Inc. of Fairfax Va. and U.S. patent application Ser. No.______ , titled “MINIATURE GUIDED WAVELENGTH MULTIPLEXED HOLOGRAPHIC STORAGE SYSTEM”, to be assigned to Starzent, Inc. of Fairfax Va., which are hereby incorporated by reference.

### TECHNICAL FIELD OF THE INVENTION

This disclosure relates generally to protein-based memories and, more specifically, to protein-based memories for holographic data storage.

### BACKGROUND OF THE INVENTION

Protein-based optical storage system approaches have emerged recently. Implementations typically have encoded or represented a single bit of information in a single small, unique physical volume in the storage medium by use of a two photon processes and more recently using a one-photon process.

In order to achieve competitive densities with today's memory systems, location precision on the order of a few microns may be required. For example, magnetic disks with 400 GB capacity have an equivalent packaged volumetric density of about 5 microns per stored bit, while at the media surface the equivalent density is on the order of 100 nm per bit (the Seagate ST3400832AS disk drive dimensions are 146 mm×101 mm×26 mm with a capacity of 400 GB, Seagate, Scott's Valley, Calif.). The magnetic disk drive industry is a mature industry with tens of billions of dollars research and product development that has enabled developing the magnetic approach to provide the necessary precision.

The required precision is probably achievable for small numbers of laser beam intersection coordinates over a small scale of surface dimensions on the order of a few millimeters. The approach is extremely complicated however when constructing, for example, a volumetric device with dimensions of 100 mm or more, which is required to achieve capacities over 100 GB to be competitive with today's magnetic disk drives.

An intersecting laser beam exposure creates two binary states representing a binary one or binary zero. In order to provide a large storage capacity, the single bit addressing structure must be replicated across a large physical volume. Such replication makes it difficult to fully utilize the dynamic range of the storage material, hence the capacity per unit volume is decreased and complications arise when attempting to implement a high capacity, relative large volume of media for commercial applications.

By directly storing single bits directly in the medium, with a one bit to one unique physical location mapping, the data recovery process is prone to errors which are strongly dependent upon local medium properties in that small region. Medium imperfections, alignment, temperature stability, and the relative percent of protein population between the bR ground state and the stable Q states become very important to maintain good signal to noise ratios which are needed to provide low error rate data recovery even when using error correcting codes.

Two-photon processes are even more complicated to implement than a one photon process and may require even more precise intersection of the light or photon sources for both writing and reading.

Characteristics of protein intermediates can also vary with the protein and genetic variants. For example the bacteriorhodopsin native protein (referred to as wild type) has very short-lived intermediates and upon illumination the intermediate transitions back to the bR ground or resting state take only 10s of milliseconds. Other genetic variants possess longer intermediates and with sequenced illumination some variants possess states that retain a nonvolatile state for years. The quantum efficiency for transition between some states can be over 50% (bR ground state to M state), but generally not for the states that provide the desirable long-lived or permanent states (the Q state). For example, the quantum efficiency for formation of the P and Q states is very low, on the order of 1% or less which in some applications limits its usefulness.

What is needed is a system and method to address the aforementioned, and related issues and easily fully utilize the available index change of a protein-based medium.

### SUMMARY OF THE INVENTION

The present invention disclosed and claimed herein, in one aspect thereof, comprises a method of storing information in a protein having long-lived nonvolatile or near-nonvolatile states. The method includes preexposing a bacteriorhodopsin medium to a preexposure pump beam for a predetermined length of time, providing a reference beam and a data beam from a coherent light source, the data beam being modulated to transmit data, and concurrently exposing the bacteriorhodopsin medium to the reference beam and the data beam for a length of time sufficient to form a holographic representation of the data in the medium. The present invention includes a method to multiplex holograms and retrieve the multiplexed holograms essentially fully utilizing the available index change in a light-sensitive protein.

### BRIEF DESCRIPTION OF THE DRAWINGS

For a more complete understanding of the present invention and the advantages thereof, reference is now made to the following description taken in conjunction with the accompanying Drawings in which:

FIG. 1 is a diagram illustrating a protein-based storage medium in a holographic storage system according to aspects of the present disclosure;

FIG. 2 is an illustration of an example of the bacteriorhodopsin photocycle with various states and intermediates that occur upon illumination;

FIG. 3 is an illustration of the use of two protein states for information storage using a traditional single photon process;

FIG. 4 illustrates the cumulative exposure fluence of a protein medium;

FIG. 5a illustrates a set of timing waveforms for exposure control; and

FIG. 5b illustrates a cumulative fluence of a protein medium when writing multiplexed holograms.

FIG. 6 illustrates an overview of various processes for writing, erasing, and reading multiplexed holograms in a protein-based medium.

### DETAILED DESCRIPTION OF THE INVENTION

The present disclosure provides methods and means for implementing a technique for storing patterns in a light sensitive protein-based medium. A variable exposure control may be used to sequence and make use of the protein's states in order to store a pattern or data. The variable exposure control may use essentially all the available index change in a protein-based medium, to write, read and erase multiplexed data. The data may be stored holographically thus providing the many performance benefits of holographic storage techniques (high data rates, high capacity, and simplified write and read apparatus compared to single bit one or two photon memory schemes). The present disclosure contemplates the use of light to cause the transition of a light sensitive protein's ground state to the desired long-lived non-volatile states and subsequently, when desired, erasure by light of the non-volatile states. The exposure control sets the duration, wavelength, intensity and sequence of exposures to generate the long-lived states, in the bacteriorhodopsin protein, from the short lived intermediate states in order to achieve a non-volatile, erasable, rewritable medium optical storage device.

The present invention disclosure contemplates efficient utilization of the dynamic range of the bacteriorhodopsin-based medium. Bacteriorhodopsin-based media that is not converted to the photocycle P state (an intermediate reached from other short-lived intermediates and which transitions to a long-lived, nonvolatile state) is once again available to participate in the recording process, so there is very little waste of the dynamic range (index change due to recording) of the medium. This invention results in a permanent recording, unless intentionally erased by a controlled exposure of an erase light beam. Reads do not substantially damage or degrade a recording due to the spectral shifts between the protein states (from when written to when reading). Specific embodiments assume the light sensitive protein is dispersed in a suitable host or matrix for the protein. Typically these have been gelatin, but can be other synthetic materials that may provide the protein a host environment with low light scatter.

The present disclosure provides a simpler, improved method of storing groups of multiple bits in a protein-based medium, simultaneously, throughout and within a small volume. The group of bits stored simultaneously do not possess a unique spatial location individually but are stored as a hologram or pattern sharing the same physical volume enabling multiplexing groups of bits in the same location.

One feature of the present disclosure is the utilization of a photosensitive protein's intermediate states in order to provide a non-volatile, rewriteable, erasable and randomly accessible holographic memory system that enables storing multiplexed holograms in multiple regions of a medium.

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

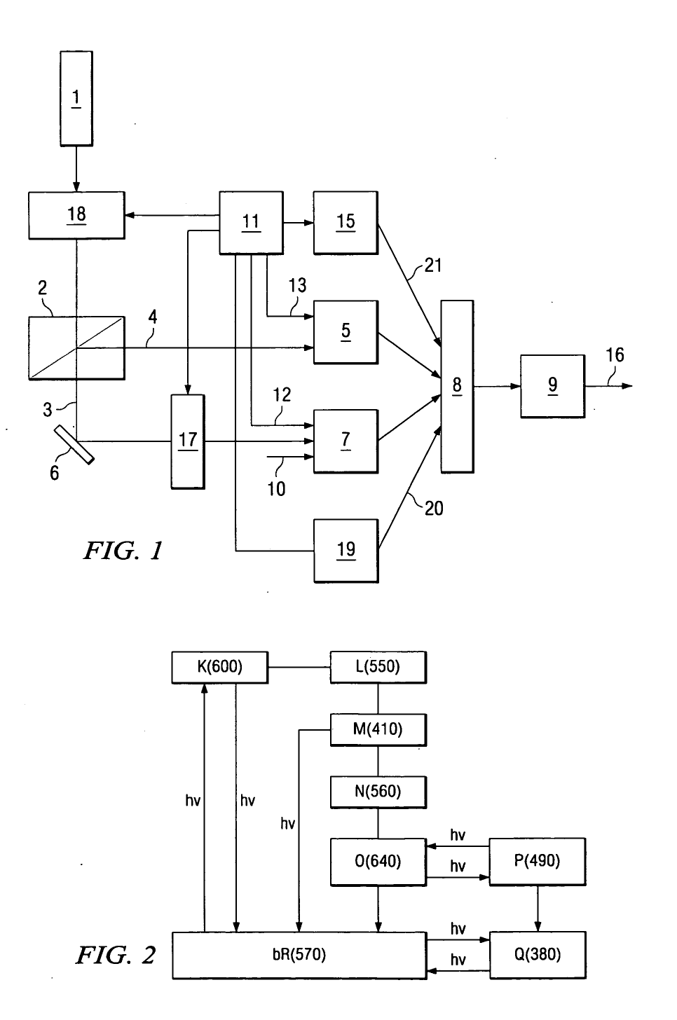

FIG. 1 is a diagram illustrating a system employing a protein-based medium in a holographic storage system according the present disclosure. The system can incorporate the various hologram-multiplexing techniques available to holographic storage, known to those studied in the art of holographic data storage. The operation of the exposure control which enables use of a protein based medium is discussed in detail in the following paragraphs.

FIG. 1 describes a system and method for storing, erasing and/or reading out multiplexed holograms representing data and preferably uses a protein-based medium that possesses a long-lived nonvolatile state (a nonvolatile state defined as a state that substantially for practical purposes remains in it's current stable state until a stimulus causes it to transition out of such stable state) and other states that when they are exposed in time, duration, sequence and intensity may transition to long-lived nonvolatile states and whose nonvolatile state furthermore can be made, upon illumination, to transition back to the bR ground or resting state in order implement a holographic data storage system.

### RECORDING EXAMPLE

Holograms can be recorded or stored as patterns in the protein-based medium by generating a sequenced timing of exposure with controlled intensity, wavelength and duration. Illumination with light at substantially 570 nm (either coherent or incoherent) will initiate a protein state transition from the bR ground state (or so called resting state) in the protein-based medium 8 to other states. The protein medium 8, upon illumination, forms metastable states K, L, M, N and O in succession. Timing box 11 begins a write process by turning on box 15 (a light source, coherent or non-coherent, at about 570 nm with addressing optics to place the light beam at the medium location where the hologram will be written) for the desired pre-hologram write exposure time and then turns box 15 off. This pre-exposure beam is referred to as a pump beam.

The control box 11 then sets the optical transmission of box 18 (containing a light valve that can be turned on or off and whose optical transmission is also adjustable). Timing box 11 also opens light valve 17. Laser 1 provides a substantially coherent source, which passes through box 18 (a light valve which has been preset) and then is split by beam splitter 2 into a signal beam 3 and reference beam 4. The signal beam continues, is reflected off mirror 6 to box 7 (which may consist of optics, an SLM, media addressing mechanisms, to position the signal beam 3 at the desired physical medium volume to interfere with the reference beam. Electrical data 10 which is to be stored as a hologram has been input to box 7 and the medium address to store the hologram. The reference beam 4 is generated by the beam splitter 2 and progresses to box 5, which may consist of optics and addressing mechanisms to position the reference beam to interfere with the signal beam on the medium 8.

Control 11 controls the medium 8 exposure for the interfering signal 3 and reference beam 4 in order to divide the total available index change between the number of holograms that will be recorded at a medium address in accordance with the desired reconstructed hologram strength. The exposure can be determined from characterization of the specific variant used in the medium. Characterization can be performed by those skilled in the art of biology, physics and or chemistry related to light sensitive proteins.

After pre-exposure with the pump beam 15, which for more sensitive bacteriorhodopsin variants could be on the order of 100 us to a millisecond, the hologram's writing duration is controlled by block 11, with a wavelength at or near 640 nm (for the bacteriorhodopsin example in FIG. 2) will cause the P state and then Q states to be generated (states K, L, M, N and O in succession having been generated by the pump beam and some O state is remaining not having not totally transitioned back to the bR ground state while the hologram is being written). The Q state is a non-volatile state, which stores the hologram. Control 11 now turns off the signal and reference beams by closing light valve 18 and 17 respectively. Light valve 17 can be turned off if a read-cycle is to follow. If another write-cycle is to follow, it may remain open.

During the writing process, metastable protein states not converted to the P state will continue to naturally to transition back to the bR ground state and become available for use in recording other multiplexed holograms.

### READING EXAMPLE

Reading of multiplexed hologram data occurs by control box 11 closing light valve 17, setting the optical transmission of light valve 18 and setting the read address in block 5 to read the desired previously written hologram physical volume on medium 8. Light valve 18 is opened and illumination is provided by laser 1 (substantially coherent and at a wavelength of 640 nm in this example corresponding to the wavelength used to write the hologram) creating the reference beam 4 from beam splitter 2. The reference beam 4 continues to box 5, which adjusts the reference beam to reconstruct (read) the desired hologram's physical volume in medium 8. The resulting hologram is reconstructed from the medium 8 to box 9, which consists of optics and the image detector to convert the hologram to an electrical signal 16. The details of the optics, imager devices and conversion of the electrical signal to data are known to those practiced in the art of holographic storage. Upon exposure of the image detector in block 9, control block 11 turns off the light valve 18.

### ERASURE EXAMPLE

Erasure of holograms or patterns may be accomplished with illumination, coherent or non-coherent, at about 380 nm at or near the absorption peak of the Q state, whose state is storing the multiplexed holograms in a physical volume on medium 8. Block 19, containing a light source with adjustable intensity at a wavelength of about 380 nm, for this example, near the Q state absorption peak and also contains optics and addressing mechanisms to position the light at the medium 8 physical volume where holograms are to be erased, is turned on for a duration by control 11 to generate the erase beam 20 which illuminates and erases the physical volume on medium 8. The duration of the erase beam and intensity is set by 11 to substantially erase the data which depending on the variant may range from milliseconds to a second.

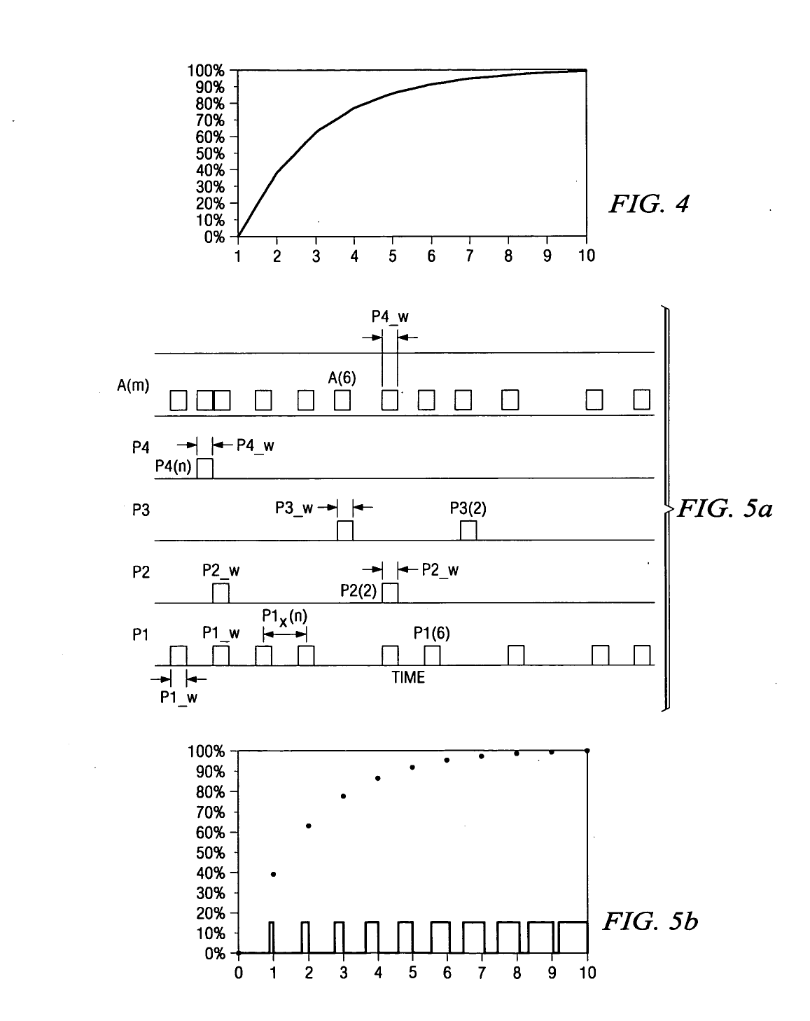

The operation of the exposure control box 11 and its effect on the protein medium on the recording, reading and erasure process can be explained from FIGS. 4, 5a, and 5b described in greater detail below.

FIG. 2 illustrates an example of the bacteriorhodopsin photocycle with the various states and intermediates that occur upon illumination. A detailed description of the various states is discussed by Wise et al in TRENDS in Biotechnology, Volume 20, Number 9, September 2002, pp 387-394, attached hereto as Appendix A, and U.S. Pat. No. 5,559,732 to Birge, hereby incorporated by reference. The times for state transitions, the molar absorption and the corresponding wavelength of the absorption peaks may vary for each genetic variant.

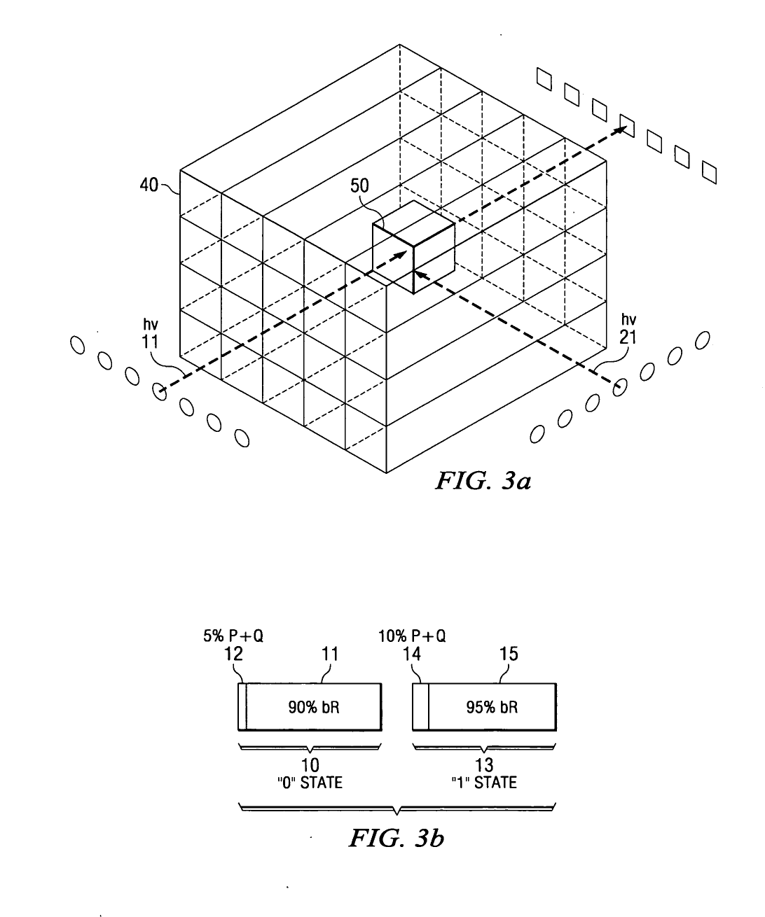

FIG. 3 illustrates the traditional one-photon process to use two protein states, bR ground state and P+Q to represent a single bit, binary data 1 and 0 respectively by the percent of the relative bR ground state and P+Q state, which is read by differences in their absorption. FIG. 3 shows the required intersection of the two beams in order to write and read data from a small volume in a 3-D memory. The small volume where the lasers intersect stores a single bit based on the relative absorption of the bR ground state and P+Q state.

FIG. 4 illustrates the cumulative exposure fluence of the protein medium, for the current invention (as opposed to the traditional one-photon process of FIG. 3), which relates to the maximum use of the available index change during exposure in order to record holographic patterns (holograms) storing data or images (which represent the desired data to be stored). FIG. 4 illustrates the effect of exposure from an interfering reference beam 4 and signal beam 3 on the medium FIG. 1, block 8. The vertical y-axis indicates the conversion of the medium upon exposure to an index-change hologram with 100% representing full conversion or saturation in that further exposure will not provide additional reconstructed hologram beam intensity upon readout. Significant exposure time (also a function of beam intensity and protein sensitivity) may be necessary to fully reach 100% use of the available index change due to inefficiency in state transitions of the protein.

FIG. 5a illustrates a set of timing waveforms and method according to the current invention for exposure control (control of wavelength, intensity, timing and duration of each illuminating beam) in order to utilize the bacteriorhodopsin protein states to store multiplexed holograms, read multiplexed holograms, erase multiplexed holograms and that may accelerate the writing of multiplexed holograms for specific medium addresses. FIG. 5a illustrates a set of write, read, pump and erase beams which show the general operation of the control block 11 and the effect on the protein-based medium 8 and that results in essentially the total use of available index change (divided among the multiplexed holograms) in the medium when recording holograms.

FIG. 5b illustrates the resulting cumulative fluence; the holographic recording, erase and read timing for the protein intermediates to achieve multiplexed hologram storage essentially using the total available index change shared between the stored holograms.

Referring now to FIGS. 5a and 5b and by providing adjustable, programmable exposure control, many holograms up to N (N=10 in the example of FIG. 5) may be written to fully utilized the available index change as shown in FIG. 5b (where the Nth hologram utilizes substantially all the remaining available dynamic range or available index change of the multiplexed holograms' medium address, such that any additional holograms cannot be written in the address, that upon reconstruction, the previously stored holograms will not have an adequate recovered signal to noise ratio for the intended application or use). In FIG. 5b, for example the first exposure intensity and duration are set to utilize 40% of the available index change. Subsequent exposures gradually use the remaining index change until essentially 100% of the available index change is used. In general for high capacity storage systems, the available index change will be divided between 1000 (N=1,000) or more holograms in a specific location on the medium. In this case a first order estimate is that each hologram will use 1/N of the available index change or 0.1 percent. As the exposure process continues and the protein molecules in a specific medium location are being converted to the Q state, then the amount remaining available for new hologram exposure is reduced. If the same write and read beam intensity were used the write time may increase in duration as the unrecorded, available bR ground state molecule population decreases. The writing intensity or pump beam intensity or duration therefore may be adjusted to reduce the impact of dwindling bR ground state molecule population on write time.

With a programmable, adjustable exposure control, many holograms up to N may be written within a physical volume to essentially utilize all the available dynamic range or index change as shown in FIG. 5b, where the Nth hologram utilizes essentially all the remaining available dynamic range or available index change of the multiplexed holograms' physical volume, such that no additional holograms may be readily written in the same physical volume, without degrading the previously stored holograms preventing acceptable retrieval of their stored data.

In FIG. 5a, P1 represents a reference beam controlled to provide the necessary duration, intensity and wavelength. P1(n) represents the nth occurrence in time of a reference beam whose function is to expose the medium in order to read an “nth” data or hologram or write an “nth” data hologram (with a timed P2(n) interfering signal beam). Other reference beam variables, controlled by control block 11, FIG. 1, for each P1(n) are the reference beams duration in time “w”, “i” beam intensity, and wavelength “λ.” Each exposing reference beam, for hologram “n,” can then be represented as P1(n, w, i, λ), where “n” is the number of the reference beam exposure from a count or time sequence (without loss of generality, the reference beam could be continuous where only the power level was changed between those useful intensities or intensities that would not effect any photocycle transition from a practical aspect), “w” is the time duration, “i” is the intensity and “λ” is the wavelength.

Likewise for the signal beam P2, P2(n) represents the nth occurrence in time of a pump beam whose function is to expose the medium in order to write an “nth” data or hologram (with a timed P1(n) interfering reference beam). Other signal beam variables, controlled by control block 11, FIG. 1, for each P2(n) are the signal beam's duration in time “w”, “i” beam intensity, and wavelength “λ”. Each exposing signal beam, for hologram “n,” can then be represented as P2(n, w, i, λ), where “n” is the number of the signal beam exposure from a count or time sequence (without loss of generality, the beam could be continuous where only the power level was changed between those useful intensities and intensities that would not effect any photocycle transition from a practical aspect), “w” is the time duration, “i” is the intensity and “λ” is the wavelength.

Likewise a P3 erase beam can be can be represented as P3(n, w, i, λ), where P3(n) represents the nth occurrence in time of a pump beam whose function is to expose the medium in order to erase. Other erase beam variables, controlled by control block 11, FIG. 1, for each P3(n) are the erase beam duration in time “w,” “i” beam intensity, and wavelength “λ.” Each exposing erase beam, for the “nth” data or hologram, can then be represented as P3(n, w, i, λ), where “n” is the number of the erase beam exposure from a count or time sequence (without loss of generality, the beam could be continuous where only the power level was changed between those useful intensities and intensities that would not effect any photocycle transition from a practical aspect), “w” is the time duration, “i” is the intensity and “λ” is the wavelength.

Likewise a P4 pump beam can be can be represented as P4(n, w, i, λ), where P4(n) represents the nth occurrence in time of a signal beam whose function is to expose the medium in order to assist the write process by initiating transitioning of the protein out of the ground or resting state. Other pump beam variables, controlled by control block 11, FIG. 1, for each P4(n) are the pump beam duration in time “w,” “i” beam intensity, and wavelength “λ.” Each exposing pump beam, for hologram “n,” can then be represented as P4(n, w, i, λ), where “n” is the number of the pump beam exposure from a count or time sequence (without loss of generality, the beam could be continuous where only the power level was changed between those useful intensities and intensities that would not effect any photocycle transition from a practical aspect), w is the time duration, “i” is the intensity and λ is the wavelength.

The variables “w”, “i” and “λ” may be changed with each “n” as desired to achieve the use of available index change and functional performance goals of the storage read, write or erase. In some embodiments it may be desirable to incorporate phase and polarization of the beams. In such a case the beams would be represented as PX(n, w, i, λ, Φ, ρ), where variables Φ and ρ represent phase and polarization respectively and PX is P1, P2, P3 . . . PX, where “X” is the needed beam type [in the above example: reference beam (X=1), signal beam (X=2), erase beam (X=3), pump beam (X=4) and so forth to define the number, types of beams needed and their characteristic} for each write, read, pump and erase operation on the medium as shown in FIG. 5a.

A(m) represents the address for the write, read, pump or erase and may range from 1 to “N,” where “N” is the total number of holograms to be stored. Blocks 5, 7, 15 and 19 incorporate holographic multiplexing mechanisms for writing and reading of “N” multiplexed holograms and translation of A(m) to a physical medium address are known to those skilled in the art. The number of usable addresses to meet performance objectives, address spacing (whether from a physical, spatial, angle, phase, wavelength or code multiplexing) to achieve a number of multiplexed holograms is also known to those skilled in the art.

Genetic variants may also have different characteristics. As a result it may be useful to program, set or adjust the control block 11 to control and use variables “n, w, i, λ, Φ, ρ” differently for different protein variants in order to expose new and future variants in accordance with the performance goals in a specific embodiment or application for storing holograms, erasing holograms and reading holograms. In the current invention this can be accomplished by adding, programming and or adjusting signal beams, reference beams, pump beams and erase beams as needed and adding additional beams as needed for example P1(“n, w, i, λ, Φ, ρ”), P2(“n, w, i, λ, Φ, ρ”), P3(“n, w, i, λ, Φ, ρ”), P4(“n, w, i, λ, Φ, ρ”), . . . to PX(“n, w, i, λ, Φ, ρ”) as required for new future variants and in other embodiments. Each beam will have illumination (intensity, timing, duration, coherency, monochromatic or non-monochromatic, polarization and phase) to expose, write, read and erase data. To those skilled in the art of providing control of optical components using hardware and software, such control may be easily generated after characterization of the new variant by those skilled in biology, chemistry and or physics with skills in characterization of genetically engineered variants of the rhodopsin family and or light sensitive proteins.

Another embodiment may add control to apply an electrical field to the medium to control protein-based medium state transitions. For example an electrical field control to the medium can assist the transitioning and forming of states. The new control can then be represented by PX(n, w, i, λ, Φ, ρ, E), which now includes control of light and an electrical field on the medium at the desired physical location to influence the bR photocycle states.

Another embodiment may use temperature to enhance or improve the exposure process. Temperature can play a key role in the performance and exposure sensitivity of a protein-based medium. The added feature for medium control including temperature can be represented as PX(n, w, i, λ, Φ, ρ, E, Ω). The temperature of the medium may be controlled by several methods, familiar to those skilled in the art of temperature control of electronic devices (physicists, electrical engineers and mechanical engineers), such as thermoelectric coolers utilizing the Peltier effect (such devices are available for example from Melcor Corporation, Trenton, N.J. 08648), or preheating the medium using high intensity illumination.

Laboratory type control software and hardware with flexibility, adaptability along with many analog input ports, output ports, digital input ports and output ports for example is sold by National Instruments Corporation, 11500 N Mopac Expressway, Austin, Tex. 78759-3504. Other implementations of programmable devices can be constructed and programmed to provide the necessary control functions for the exposures PX(n, w, i, λ, Φ, ρ, E, Ω) to those skilled in the art.

Control block 11 may be adjusted or programmed to expose variants whose intermediate states may be in a totally different order than the bacteriorhodopsin example of FIG. 2. Control block 11 may be adjusted to expose variants that may have only 2, states, 3 states or many states and whose absorption spectrum may be shifted to significantly in higher or lower wavelength with significantly different and varying molar absorption coefficients. To those skilled in using hardware and software to generate control of optical components, a design may be adjusted that will provide exposure of a resting state in order to cause the protein to transition to intermediate states and if the protein has the ability to transition from intermediate states to a long-lived state, control may be adjusted in order to cause transition into the long-lived state. Furthermore control may be adjusted or programmed to provide exposure to transition the protein from the long-lived state back to the ground or resting state if such a transition exists in the protein variant, which is referred to as erasure.

Should a protein variant possess a stable long lived state, the control block 11 may be adjusted or programmed to proved the necessary exposure to read a hologram or plurality of holograms that have been written into a non-volatile or long lived state.

The details of control in FIG. 1 and exposure processes described along with the timing example in FIG. 5a are for illustrative purposes for a variant similar to the bacteriorhodopsin protein. Depending upon the desired holographic system performance, changes can be made to the embodiment of FIG. 1. For example, it may be possible to use a laser source as a pump beam and not use block 15 as a pump source when the laser beam is of the proper wavelength and intensity for the protein variant chosen. Depending on system goals, other embodiments may temporally overlap the pump beam with the write beam temporarily during recording. Some embodiments may not use a pump beam depending on the performance goals and characterization of the variant used, but let the laser used for write and read be used for pumping (although such an approach may not permit writing data to the media as fast as would be possible when using a separate pump beam). In the most general embodiment a laser source that has computer controlled, adjustable output power and wavelength may provide both the erase and pump beams in addition to being the source for the signal and reference beams.

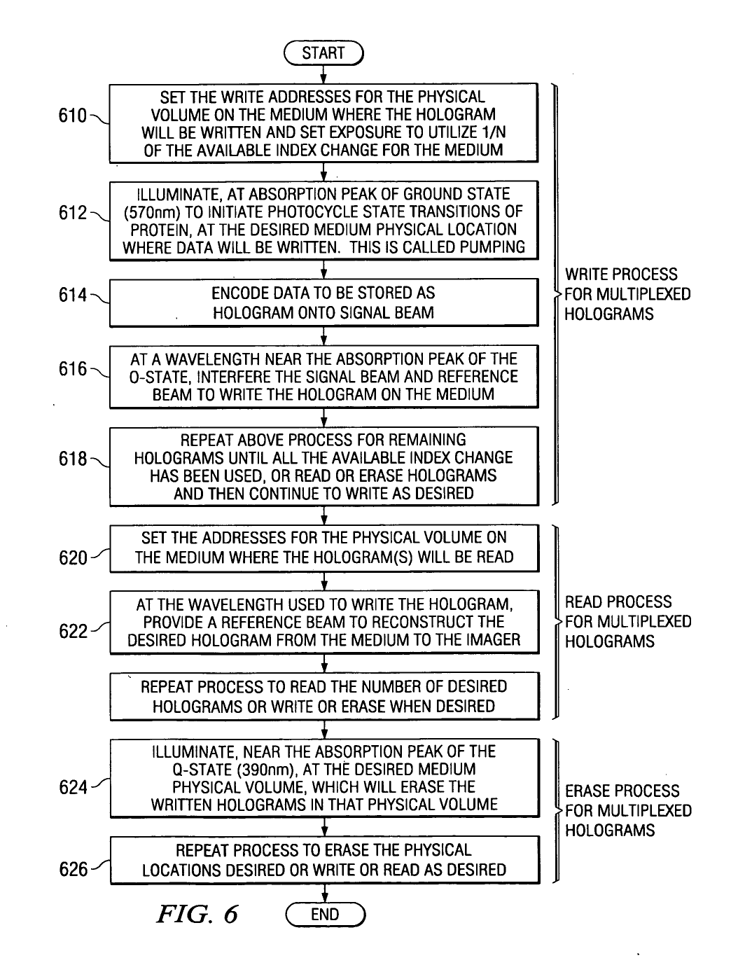

Referring now to FIG. 6, an overview of various processes for use with multiplexed holograms is shown. FIG. 6 provides a top-level view of the processes and methods previously described herein.

It will be appreciated by those skilled in the art having the benefit of this disclosure that this invention provides a method of storing information in a protein having a long-lived nonvolatile or near-nonvolatile states. The method includes preexposing a bacteriorhodopsin medium to a preexposure pump beam for a predetermined length of time, providing a reference beam and a data beam from a coherent light source, the data beam being modulated to transmit data, and concurrently exposing the bacteriorhodopsin medium to the reference beam and the data beam for a length of time sufficient to form a holographic representation of the data in the medium.

It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

1. A method of storing information in a protein having long-lived nonvolatile or near-nonvolatile states comprising:
preexposing a bacteriorhodopsin medium to a preexposure pump beam for a predetermined length of time;
providing a reference beam and a data beam from a coherent light source, the data beam being modulated to transmit data; and
concurrently exposing the bacteriorhodopsin medium to the reference beam and the databeam for a length of time sufficient to form a holographic representation of the data in the bacteriorhodopsin medium.

2. A method of storing information in a protein having long-lived nonvolatile or near-nonvolatile states comprising:
exposing a protein-based holographic medium to a light source with an intensity and duration sufficient to form metastable states K, L, M, N, and O;
exposing the protein-based holographic medium to a coherent reference light source;
exposing the protein-based based holographic medium to a coherent data light source modulated to contain holographic data; and
continuing the exposure of the protein-based based holographic medium to the reference light source and the data light source until P states and Q states are generated.

3. The method of claim 2, further comprising recreating the holographic data by exposing the protein-based holographic media to the reference light.

4. The method of claim 2, wherein the protein-based holopgraphic medium is a bacteriorhodopsin medium.

5. The method of claim 2, wherein the coherent reference light source is a laser.

6. The method of claim 2, wherein the coherent data light source is a laser.

7. The method of claim 2, further comprising:
exposing the holographic medium to a reference light source thereby recreating the modulated holographic data; and
converting the holographic data into an electrical signal with an image detector.

8. The method of claim 2, further comprising erasing the holographic data by exposing the holographic medium to light having a wavelength substantially at the absorption peak of the Ω state of the holographic medium.

9. The method of claim 2, further comprising exposing the holographic medium to an electric field.

10. The method of claim 2, further comprising controlling a temperature of the holographic medium.

11. The method of claim 1, further comprising:
remodulating the data beam to transmit additional data;
concurrently exposing the bacteriorhodopsin medium to the reference beam and the data beam for a second length of time sufficient to form a second holographic representation of the additional data in the bacteriorhodopsin medium at an address different from an address of the original holographic representation.

12. The method of claim 1, further comprising erasing the holographic representation of the data by exposing the bacteriorhodopsin medium to light having a wavelength substantially at the absorption peak of the Ω state of the bacteriorhodopsin medium.

13. The method of claim 1, further comprising:
exposing the bacteriorhodopsin medium to a reference light source thereby recreating the holographic representation; and
converting the holographic representation into an electrical data signal with an image detector.

14. The method of claim 1, wherein the reference beam is a laser.

15. The method of claim 1, wherein the data beam is a laser.

16. The method of claim 1, further comprising exposing the bacteriorhodopsin medium to an electric field.

17. The method of claim 1, further comprising heating the bacteriorhodopsin medium.

18. A method of A method of storing information in a protein having long-lived nonvolatile or near-nonvolatile states comprising:
preexposing a bacteriorhodopsin medium to a preexposure pump beam for a predetermined length of time;
providing a reference beam and a data beam from a coherent light source, the data beam being modulated to transmit a first data set;
concurrently exposing the bacteriorhodopsin medium to the reference beam and the databeam for a length of time sufficient to form a holographic representation of the first data set in the bacteriorhodopsin medium;
modulating the data beam to transmit a second data set; and
concurrently exposing the bacteriorhodopsin medium to the reference beam and the databeam for a length of time sufficient to form a holographic representation of the second data set in the bacteriorhodopsin medium;
wherein the first data set and the second data set are stored in first and second address locations, respectively, thereby creating a multiplexed hologram in the bacteriorhodopsin medium.

19. The method of claim 18, further comprising preheating the bacteriorhodopsin medium using high intensity illumination.

20. The method of claim 18, further comprising applying an electric field to the bacteriorhodopsin medium.
